(19) United States
(12) Patent Application Publication
(10) Pub. No.: US 2003/0231555 A1
(43) Pub. Date: Dec. 18, 2003

(54) Custom designed time piece

(76) Inventor: Brian E. Sullivan, Alta Loma, CA (US)

Correspondence Address: SHELDON & MAK, 9th Floor, 225 South Lake Avenue, Pasadena, CA, 91101, US

(21) Appl. No.: 10/172,667

(22) Filed: Jun. 14, 2002

(51) Int. Cl. G04C 17/00; G04B 19/00; G04B 25/00

(52) U.S. Cl. 368/223

(57) ABSTRACT

A custom designed and personalized time piece comprises a case, a face, a time keeping mechanism, an hour hand spindle and a minute hand spindle. A personal photographic image provided by a customer is divided into a torso and head portion, a first appendage portion and a second appendage portion. The second appendage portion is appended to the hour hand and the first appendage portion is appended to the minute hand. The torso and head portion is disposed between the hour hand and the minute hand.

### FIELD OF THE INVENTION

This invention relates generally to time pieces, such as clocks and watches and, more specifically, to time pieces having the persona of a person or other animal illustrated therein.

### BACKGROUND OF THE INVENTION

Time pieces, such as watches and clocks having images of cartoon characters, real people or other animal illustrated therein, have been popular for many years. The images illustrated in such time pieces are, for the most part, images chosen by the time piece manufacturer.

Recently, some purveyors of time pieces have also offered the buying customer a choice of background illustrations disposed on the face portion of the time piece. In most cases, the customer chooses a background illustration from a set of pre-prepared background illustrations. In some cases, however, a photograph provided by the customer has been appended to the face portion of the time piece, thereby personalizing the time piece of the customer. Unfortunately, such personalized time pieces are totally static, the hour hand and the minute hand of such time pieces being not personalized in any way.

Accordingly, time pieces having images are either wholly chosen by the manufacturer or wholly static. Therefore, there is a need for a personalized time piece which can be custom designed by the end customer wherein both the face of the time piece and the hands of the time piece are personalized to the customer.

### SUMMARY

The invention satisfies this need. In one embodiment, the invention is a method of custom designing and manufacturing an individual time piece. The method comprises the steps of (a) providing a time piece blank having a case, a face and a time keeping mechanism disposed within the case, the timekeeping mechanism comprising a minute hand spindle and an hour hand spindle, (b) identifying from a specific customer for the time piece a specific subject of the animal family whose image is desired to be used in the custom design of the face and hands of the time piece, (c) obtaining from the customer, or obtaining for the customer, at least one photographic image of the subject of the animal family identified in step (b), (d) separating the at least one photographic image obtained in step (c) into a torso and head portion, a first appendage portion and a second appendage portion, (e) appending the torso and head portion to the time piece face, (f) appending the first appendage portion to the minute hand spindle such that the first appendage portion appears to be anatomically correct with respect to the torso and head portion, and (g) appending the second appendage portion to the hour hand spindle such that the second appendage portion appears to be anatomically correct with respect to the torso and head portion.

In a second embodiment, the invention is a custom designed time piece comprising (a) a case, (b) a face, (c) a time keeping mechanism disposed within the case, the time keeping mechanism comprising concentrically disposed minute and hour hand spindles, and (d) an hour hand attached to the hour hand spindle and a minute hand attached to the minute hand spindle; wherein a multiple layer image, comprising at least three layers, is disposed above the face, the image being that of an animal having a torso and head portion, a first appendage portion and a second appendage portion,

In a third embodiment, the invention is a system for selling custom design time pieces. The system comprises (a) a computer for (i) receiving and storing in digital form one or more photographs of an animal designated by a customer, and for (ii) digitally altering and parsing the one or more photographs to yield a torso and head portion, a first appendage portion and a second appendage portion, (b) a printer for printing the torso and head portion, the first appendage portion and the second appendage portion onto a photographic print media, (c) a laser cutting tool for cutting out the printed torso and head portion, the first appendage portion and the second appendage portion, and (d) a time piece inventory comprising a plurality of time piece blanks, each time piece blank comprising a case, a face and a time keeping mechanism disposed within the case, the time keeping mechanism comprising a minute hand spindle and an hour hand spindle.

### DRAWINGS

These features, aspects and advantages of the present invention will become better understood with regard to the following description, appended claims and accompanying figures where:

FIG. 1 is a plan view of a time piece having features of the invention;

FIG. 2 is a plan view of a first photograph useful in the construction of the time piece illustrated in FIG. 1;

FIG. 3 is a second photograph useful in the construction of the time piece illustrated in FIG. 1;

FIG. 4 illustrates how the photographs illustrated in FIGS. 2 and 3 are parsed to yield manufacturing components for the time piece illustrated in FIG. 1;

FIG. 5 is an isometric view of a portion of a time piece having features of the invention;

FIG. 6 is a side view of the portion of the time piece illustrated in FIG. 5; and

FIG. 7 is a schematic view of a system having features of the invention.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

In one embodiment, the invention is a method of custom designing and manufacturing an individual time piece 10, such as a clock or watch. The method comprises seven steps as described below.

In the first step, a time piece blank is provided. The time piece blank comprises a case 12, a face 14 and a time keeping mechanism 16 disposed within the case 12, the time keeping mechanism 16 comprising a minute hand spindle 18 and an hour hand spindle 20.

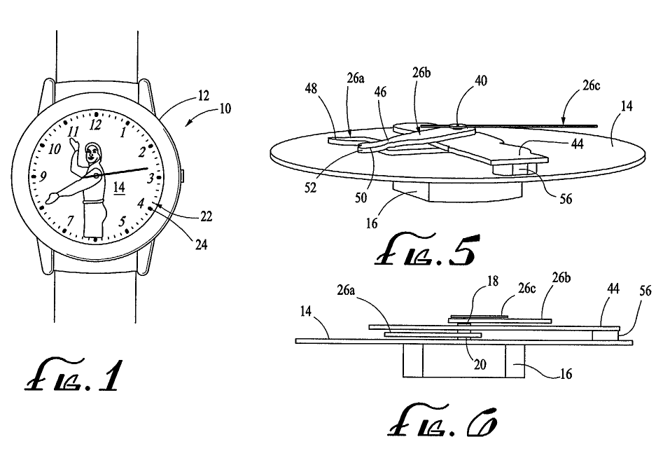

The case 12 can be any of the myriad of time piece cases known in the art, including clock cases and watch cases. In the embodiment illustrated in FIG. 1, the case 12 is a watch case and the time piece is a wrist watch.

The time keeping mechanism 16 can also be any of the several time keeping mechanisms known in the art. The time keeping mechanism 16 can be analog or digital and can be powered by mechanical means, hardwired electrical connections or electrical storage batteries.

The face 14 can be any typical time piece face of the traditional analog style. The face 14 typically has a dial 22 with a plurality of hour indication marks 24 disposed in a continuous loop, traditionally a circle. The minute hand spindle 18 and the hour hand spindle 20 are concentrically disposed proximate to the center of the face 14.

The second step in the method of the invention is to identify from a specific customer for the time piece 10 a specific subject of the animal family whose image is desired to be used in the custom design of the face 14 and hands 26 of the time piece 10.

The subject of the animal family is typically a human being. The subject can be the customer himself (or herself) or it can be another. Such another is typically a loved one or a famous personage held in esteem by the customer. The subject can also be a non-human subject, for example, a pet of the customer such as a dog or cat. The invention is not restricted to any particular species of the animal family, and is not restricted to mammals.

The third step in the method of the invention is to obtain from the customer, or to obtain for the customer, at least one photographic image 28 of the subject of the animal family identified in the second step. In a typical application of the method, the customer provides the at least one photographic image 28. However, if the customer does not have the at least one photographic image 28 but can provide the subject itself, the subject can be photographed by the practitioner of the method to provide the at least one photographic image 28.

The customer can interact with the practitioner of the method in any of a wide varieties of ways, such as in person, via telephone, via the mail or via the Internet. In one application of the invention, the customer interacts with the practitioner of the method via the Internet by providing a Website on the Internet which offers instructions regarding how to take the one or more photographs, how to mail them to the practitioner of the method or how to upload them to the Website server 30 and how to order and pay for the custom designed time piece.

The customer can also provide the practitioner of the method with a hard copy of the at least one photographic image 28 to be used in the time piece 10. The practitioner of the method then digitally scans the at least one photographic image 28 to provide a digital representation of the photograph, and then the practitioner loads that digital representation into a computer 32 for further processing as discussed below.

In a preferred embodiment illustrated in FIGS. 2 and 3, the at least one photographic image 28 comprises two photographic images, a first photographic image 28a and a second photographic image 28b. The first photographic image 28a can be a side view of a human being taken with a camera lens disposed approximately at the same level as the subject shoulder. In this first photographic image 28a, one arm 34 of the subject is shown in the foreground which is extended forwardly straight and declined from the horizontal at a first angle of declination α of between about 30° and about 60°. The second photographic image 28b is preferably the same side view as the first photographic image 28a except that the arm 34 shown in the foreground is extended straight rearwardly and declined from the horizontal at a second angle of declination β between about 45° and about 80°, and the second arm 36 of the human being is shown in the background disposed approximately horizontal with the forearm portion 38 being disposed approximately vertically and, more preferably, with the palm of the hand 42 being disposed upwardly.

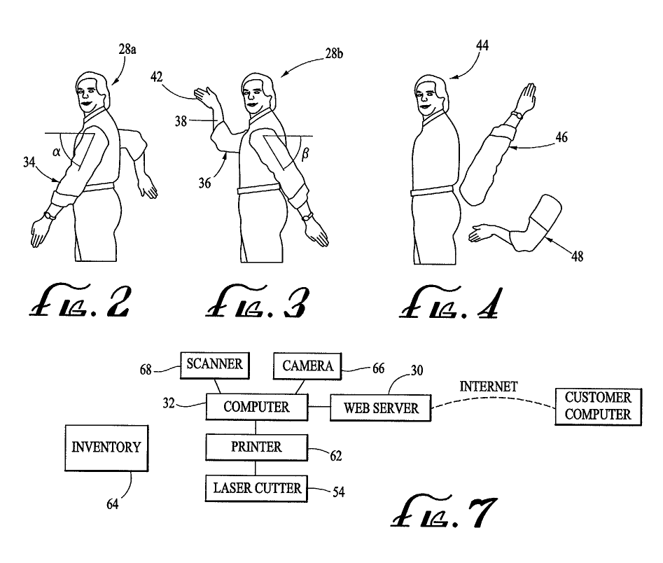

The fourth step in the method of the invention is to separate the at least one photographic image 28 obtained in the third step into a torso and head portion 44, a first appendage portion 46 and a second appendage portion 48. This step is illustrated in FIG. 4. Typically, this step is accomplished with a computer 32 using one of the many computer programs for altering photographic images. One such computer program is PHOTOSHOP® sold by Adobe Systems, Inc. of San Jose, Calif.

In a typical embodiment, where the subject is a human being the first appendage portion 46 is one of the two arms or two legs of the human being and the second appendage portion 48 is the other of the two arms or legs of the human being. In embodiments of the invention where the subject is an animal other than a human being, the first appendage portion 46 can be a first leg and the second appendage portion 48 can be a second leg. In other embodiments, other appendages of the subject matter animal can be used, such as a tail, a wing, a flipper, etc.

The torso and head portion 44, the first appendage portion 46 and the second appendage portion 48 are typically printed onto a suitable photographic print media 50. Typically, the photographic print media 50 containing the images of the three portions 44, 46 and 48 is then laminated to a stiff backing material 52, such as “Capton” polymer manufactured by E. I. du Pont de Nemours and Company, of Wilmington, Del. The backing material 52 can be any backing material suitable for use as time piece hands for being press fit over time piece movement spindles.

After being printed and laminated, the torso and head portion 44, the first appendage portion 46 and the second appendage portion 48 are cut out using a laser cutting tool 54. This can be efficiently accomplished using a laser cutting tool 54 by first creating a separate computer file for the photographic image of each portion 44, 46 and 48 and then manipulating each such separate file to be “black and white” images only. Such “black and white” images can then be conveniently used as a laser path for the laser cutting tool 54 to follow in the cutting out of the three portions 44, 46 and 48.

The fifth step of the method of the invention is to append the second appendage portion 48 to the hour hand spindle 20 to provide an hour hand 26a, such that the hour hand 26a is disposed in close proximity to the face 14 of the time piece 10. This provides a first layer in what will become a three-layer image of the subject disposed above the time piece face 14.

The sixth step of the method of the invention is to append the torso and head portion 44 to the time piece face 14. This is most conveniently accomplished by attaching a spacer 56 to the time piece face 14 at a location spaced apart from the hour hand spindle 20 and minute hand spindle 18, and then attaching the torso and head portion 44 to the spacer 56. The torso and head portion 44 is disposed such that the hour hand 26a is sandwiched between the face 14 of the time piece 10 and the torso and head portion 44. The appending of the hour hand 26a and the torso and head portion 44 is accomplished is such a way that the second appendage portion 48 appears to be anatomically correct with respect to the torso and head portion 44.

The seventh step of the method of the invention is to append the first appendage portion 46 to the minute hand spindle 18 to provide a minute hand 26b, in such a way that the first appendage portion 46 appears to be anatomically correct with respect to the torso and head portion 44. In embodiments where the first appendage portion 46 and the second appendage portion 48 depict the two arms of a human being, the hour hand spindle 20 and the minute hand spindle 18 are disposed through the shoulder area of the torso and head portion 44. In embodiments where the first appendage portion 46 and the second appendage portion 48 depict the two legs of a human being, the hour hand spindle 20 and the minute hand spindle 18 are disposed through the hip area of the torso and head portion 44.

The minute hand 26b is typically disposed above the torso and head portion 44, such that the torso and head portion 44 is sandwiched between the hour hand 26a and the minute hand 26b. The resulting assemblage provides a three-layer image of the subject disposed above the face 14 of the time piece 10. This is illustrated in FIGS. 5 and 6.

The method can further comprise the step of appending a background photographic image (not shown) directly to the face 14 of the time piece 10.

The method can also further comprise the step of adding a second hand 26c or a second indicating disk (not shown) to a second hand spindle 40 on the time piece 10.

The invention is also the embodiment of the completed time piece 10, such as is illustrated in FIGS. 1, 5 and 6. The completed time piece 10 is a unique custom time piece with an anatomically correct subject disposed within a unique three-layer (i.e., three dimensional) look.

In another embodiment of the invention, the invention is a system 60 for selling custom designed time pieces 10. As illustrated in FIG. 7, the system 60 comprises a computer 32 for (i) receiving and storing in digital form one or more photographs of an animal designated by a customer, and for (ii) digitally altering and parsing the one or more photographs to yield a torso and head portion 44, a first appendage portion 46 and a second appendage portion 48. The system 60 further comprises (i) a printer 62 for printing the torso and head portion 44, the first appendage portion 46 and the second appendage portion 48 onto a photographic print media 50, (ii) a laser cutting tool 54 for cutting out the printed torso and head portion 44, the first appendage portion 46 and the second appendage portion 48, and (iii) a time piece inventory 64 comprising a plurality of time piece blanks, each time piece blank comprising a case 12, a face 14 and a time keeping mechanism 16 disposed within the case 12, the time keeping mechanism 16 comprising a minute hand spindle 18 and an hour hand spindle 20.

The system 60 of the invention can be used to append the torso and head portion 44 to the face 14 of one of the time piece blanks in the time piece inventory 64, the first appendage portion 46 to the minute hand spindle 18 of the time piece blank and the second appendage portion 48 to the hour hand spindle 20 of the time piece blank to yield a custom designed time piece 10.

The system can further comprise a digital camera 66 for taking one or more photographs of the animal designated by the customer.

The system can also further comprise a digital scanner 68 for scanning one or more photographs provided by the customer to provide the one or more photographic images 28 in digital form for input into the computer 32.

The system can further comprise a server 30 adapted to host a Website, the Website comprising instructions regarding how to take the one or more photographs, how to upload those photographs to the server, and how to order and pay for the custom designed time piece 10.

The invention provides an efficient system and method for making an inexpensive, totally individual, custom-made time piece having a unique three-dimensional appearance. Although the time piece is totally individualized to the customer, the time piece can be efficiently manufactured using the method and the system by a wide variety of customer contact methods, including face-to-face contact, telephone contact, regular mail contact, e-mail contact and contact via an Internet Website.

Having thus described the invention, it should be apparent that numerous structural modifications and adaptations may be resorted to without departing from the scope and fair meaning of the instant invention as set forth hereinabove and as described hereinbelow by the claims.

What is claimed is:

1. A method of custom designing and manufacturing an individual time piece having a face, an hour hand and a minute hand, the method comprising the steps of:
(a) providing a time piece blank having a case, a face and a time keeping mechanism disposed within the case, a time keeping mechanism comprising a minute hand spindle and an hour hand;
(b) identifying from a specific customer for the time piece a specific subject of the animal family whose image is desired to be used in the custom design of the face and hands of the time piece;
(c) obtaining from the customer, or obtaining for the customer, at least one photographic image of the subject of the animal family identified in step (b);
(d) separating the at least one photographic image obtained in step (c) into a torso and head portion, a first appendage portion and a second appendage portion;
(e) appending the second appendage portion to the hour hand spindle such that the second appendage acts as the hour hand of the time piece;
(f) appending the torso and head portion to the time piece face such that the hour hand is disposed between the face and the torso and head portion and such that the second appendage portion appears to be anatomically correct with respect to the torso and head portion; and
(g) appending the first appendage portion to the minute hand spindle such that the first appendage acts as a minute hand of the time piece and such that the torso and head portion is disposed between the hour hand and the minute hand, the first appendage portion being disposed to the minute hand spindle such that the first appendage portion appears to be anatomically correct with respect to the torso and head portions.

2. The method of claim 1 wherein the subject of the animal family is a human being.

3. The method of claim 2 wherein the first appendage portion depicts one arm of the human being and the second appendage portion depicts the second arm of the human being.

4. The method of claim 3 wherein the first appendage portion depicts the second arm of the human being cocked at the elbow at an angle between about 45° and about 170°.

5. The method of claim 3 wherein the at least one photographic image obtained in step (c) of claim 1 is a side view of a human being showing one arm in the foreground and one arm in the background, the arm in the foreground being extended straight and the arm in the background being cocked at the elbow at an angle of between about 45° and about 170°.

6. The method of claim 3 wherein the at least one photographic image comprises two photographic images, (i) a first photographic image which is a side view of a human being showing one arm in the foreground, the arm in the foreground being extended forwardly straight and declined from the horizontal at a first angle of declination of between about 30° and about 60°, and (ii) a second photographic image which is the same side view as depicted in the first photographic image, except that one arm, shown in the foreground, is extended straight rearwardly and declined from the horizontal at a second angle of declination between about 45° and about 80° and a second arm, shown in the background, has an upper arm which is disposed approximately horizontally and a forearm which is disposed approximately vertically, the palm of the hand on the second arm being disposed upwardly.

7. The method of claim 6 wherein the first appendage portion is the arm in the foreground of the first photographic image and the second appendage is the arm in the background in the second photographic image.

8. The method of claim 1 wherein the torso and head portion, the first appendage portion and the second appendage portion are prepared using a laser cutting tool.

9. The method of claim 1 wherein the step of obtaining at least one photographic image comprises the step of taking a photograph of an animal requested by the customer.

10. The method of claim 1 wherein the torso and head portion, the first appendage and the second appendage are disposed proximate to one another to form a multiple layer image, the multiple layer image being comprised of at least three layers and being disposed in front of the face, the hour hand being disposed within a first layer, the torso and head portion being disposed within a second layer and the minute hand being disposed within a third layer, the second layer being sandwiched between the first layer and the third layer.

11. A custom designed time piece comprising:
(a) a case;
(b) a face; and
(c) a time keeping mechanism disposed within the case, the time keeping mechanism comprising concentrically disposed minute and hour hand spindles;
wherein a multiple layer image, comprising at least three layers, is disposed above the face, the image being that of an animal having a torso and head portion, a first appendage portion and a second appendage portion, the second appendage portion being disposed in a first layer proximate to the face, the torso and head portion being disposed in a second layer proximate to the first layer and the first appendage being disposed in a third layer proximate to the second layer, the second layer being sandwiched between the first layer and the third layer.

12. The custom designed time piece of claim 11 wherein the first appendage portion and the second appendage portion are disposed proximate to the torso and head portion such that they appear to be anatomically correct with respect to the torso and head portion.

13. A custom designed time piece comprising:
(a) a case;
(b) a face; and
(c) a time keeping mechanism disposed within the case, the time keeping mechanism comprising concentrically disposed minute and hour hand spindles;
wherein the face comprises a side view image of a human being, the side view image being disposed on the face such that the hour hand spindle and the minute hand spindle are disposed through the shoulder of the human being in the side view image;
wherein the minute hand depicts a first arm of the human being shown in an extended and straight orientation; and
wherein the hour hand depicts a second arm of the human being, the second arm being depicted in a cocked position and wherein the forearm is cocked at the elbow at an angle less than 180°.

14. The custom designed time piece of claim 13 wherein the hour hand is disposed between the face and the side view image and the side view image is disposed between the hour hand and the minute hand.

15. The custom design time piece of claim 13 wherein the forearm is cocked at the elbow at an angle between about 45° and 170°.

16. The method of claim 13 wherein the side view image, the first arm and the second arm are disposed proximate to one another to form a multiple layer image, the multiple layer image being comprised of at least three layers and being disposed in front of the face, the hour hand being disposed in a first layer proximate to the face, the side view image being disposed in a second layer and the minute hand being disposed in a third layer, the second layer being sandwiched between the first layer and the second layer.

17. A system for selling custom designed time pieces comprising:
(a) a computer for (i) receiving and storing in digital form one or more photographs of an animal designated by a customer, and for (ii) digitally altering and parsing the one or more photographs to yield a torso and head portion, a first appendage portion and a second appendage portion;
(b) a printer for printing the torso and head portion, the first appendage portion and the second appendage portion onto a photographic print media;
(c) a laser cutting tool for cutting out the printed torso and head portion, the first appendage portion and the second appendage portion; and
(d) a time piece inventory comprising a plurality of time piece blanks, each time piece blank comprising a case, a face and a time keeping mechanism disposed within the case, the time keeping mechanism comprising a minute hand spindle and an hour hand spindle;
so that the torso and head portion can be appended to the face of one of the time piece blanks in the time piece inventory, the first appendage can be appended to the minute hand spindle and the second appendage can be appended to the hour hand spindle to yield a custom designed time piece.

18. The system of claim 17 further comprising a digital camera for taking the one or more photographs of an animal designated by the customer.

19. The system of claim 17 further comprising a digital scanner for scanning one or more photographs provided by the customer to provide the one or more photographs in digital form for input into the computer.

20. The system of claim 17 further comprising a server adapted to host a Website, the Website comprising instructions regarding how to take the one or more photographs, how to upload those photographs to the server and how to order and pay for the custom designed time piece.
